(19) United States
(12) Patent Application Publication
(10) Pub. No.: US 2016/0063313 A1
(43) Pub. Date: Mar. 3, 2016

(54) AD-HOC, FACE-RECOGNITION-DRIVEN CONTENT SHARING

(71) Applicant: HEWLETT-PACKARD DEVELOPMENT COMPANY, L.P., Houston, TX (US)

(72) Inventors: Thomas E. Sandholm, Palo Alto, CA (US); Anupriya Ankolekar, Palo Alto, CA (US)

(21) Appl. No.: 14/784,050

(22) PCT Filed: Apr. 30, 2013
(86) PCT No.: PCT/US2013/038909

§ 371 Date: Oct. 13, 2015

(51) Int. Cl. G06K 9/00; G06F 17/30; G06K 9/66; H04L 29/06

(52) U.S. Cl. CPC G06K 9/00288; H04L 65/403; G06F 17/30256; G06K 9/00268; G06K 9/66

(57) ABSTRACT

Example embodiments relate to ad-hoc, face-recognition-driven content sharing. In example embodiments, a system matches a face in a face image extracted from a video stream from a sharing device to a face profile of a receiving user, where the face profile of the receiving user is generated based on a training face image that is extracted from a training video stream of a training device of the receiving user. In response to generating a temporary token that is associated with the face profile, the system sends the temporary token and an arbitrary handle from the face profile to the sharing device. At this stage, the system receives a context identifier from the sharing device and provides the context identifier to the receiving device of the receiving user.

### BACKGROUND

Face recognition has been used to authenticate users for various web services such as social networks. In these cases, face recognition is typically used as a substitute for standard authentication techniques. Features may be provided to increase the security of the face recognition authentication. For example, multiple image captures of the face may be performed so that a web service can ensure the two images are not identical and therefore represents a live user rather than a photograph. In another example, face recognition may be combined with other biometrics (e.g., iris identification, fingerprint identification, vocal identification, etc.) to enhance recognition performance. Without these enhancements, face recognition based authentication may be susceptible to infiltration by the use of a simple photograph of a user.

### BRIEF DESCRIPTION OF THE DRAWINGS

The following detailed description references the drawings, wherein:

FIG. 1 is a block diagram of an example computing device for detecting a receiving user for ad-hoc, face-recognition-driven content sharing;

FIG. 2 is a block diagram of an example cloud server for providing ad-hoc, face-recognition-driven content sharing;

FIG. 3 is a block diagram of an example computing device in communication with a cloud server for providing ad-hoc, face-recognition-driven content sharing;

FIG. 4A is a flowchart of an example method for execution by a computing device for detecting a receiving user for ad-hoc, face-recognition-driven content sharing;

FIG. 4B is a flowchart of an example method for execution by a cloud server for providing ad-hoc, face-recognition-driven content sharing;

FIG. 5 is a flowchart of an example method for execution by a cloud server for face recognition training and providing smart content feeds for document collaboration; and

FIG. 6 is a diagram of an example context in which content is shared by ad-hoc, face-recognition-driven authentication.

### DETAILED DESCRIPTION

As detailed above, face recognition systems may allow users to more easily access web services. For example, a mobile phone equipped with a forward-facing camera may allow a user to use face recognition to authenticate his access to a social network. However, face recognition may lack security or behave inconsistently in low lighting as discussed above. Instead, location-based techniques such as near field communication (NFC) or quick response (QR) codes may be used to quickly provide information to a mobile device. For example, a user may scan a QR code with his mobile phone to quickly access a web address or other shared content. In this example, other mobile devices such as tablets or laptop computers may have difficulty consuming a QR code because such devices are not typically equipped with rear-facing cameras.

Various biometrics such as face recognition, iris identification, fingerprint identification, or vocal identification may be used to facilitate authentication. In this manner, the authentication of a user may be simplified because the user does not have to recall login credentials, but the use of biometric authentication may result in unforeseen security issues. Further, visual recognition techniques may be inconsistent depending on the lighting conditions of the environment.

Example embodiments disclosed herein provide ad-hoc, face-recognition-driven content sharing. For example, in some embodiments, a system matches a face in a face image from a sharing device to a face profile of a receiving user, where the face profile of the receiving user was generated based on a training face image that is extracted from a training video stream of a training device of the receiving user. In response to generating a temporary token that is associated with the face profile, the system may send the temporary token and an arbitrary handle from the face profile to the sharing device. At this stage, the system may receive a context identifier from the sharing device and use the temporary token to provide the context identifier to the receiving device of the receiving user.

In this manner, example embodiments disclosed herein simplify content sharing by using ad-hoc face recognition to identify potential receiving users in the current video stream (i.e., current physical context). Specifically, by monitoring a video stream for pre-registered receiving users, content may be shared to registered receiving devices in a natural manner as users enter a field of view of a camera device that is capturing the video stream. Thus, content sharing between two arbitrary devices may be facilitated because receiving devices without hardware such as cameras. QR code readers, or NFC tag readers may be manually confirmed using the sharing device.

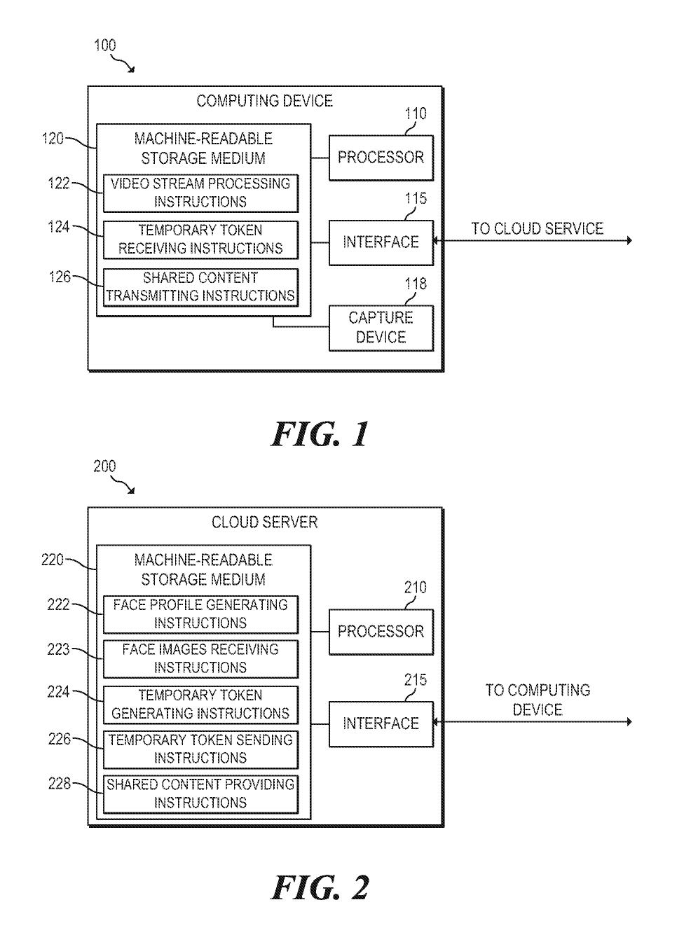

Referring now to the drawings, FIG. 1 is a block diagram of an example computing device 100 for detecting a receiving user for ad-hoc, face-recognition-driven content sharing. Computing device 100 may be any computing device (e.g., smartphone, tablet, laptop computer, desktop computer, etc.) capable of accessing a cloud server, such as cloud server 200 of FIG. 2. In the embodiment of FIG. 1, server computing device 100 includes a processor 110, an interface 115, a capture device 118, and a machine-readable storage medium 120.

Processor 110 may be one or more central processing units (CPUs), microprocessors, and/or other hardware devices suitable for retrieval and execution of instructions stored in machine-readable storage medium 120. Processor 110 may fetch, decode, and execute instructions 122, 124, 126 to enable detection of a receiving user for ad-hoc, face-recognition-driven content sharing. As an alternative or in addition to retrieving and executing instructions, processor 110 may include one or more electronic circuits comprising a number of electronic components for performing the functionality of one or more of instructions 122, 124, 126.

Interface 115 may include a number of electronic components for communicating with a cloud server. For example, interface 115 may be an Ethernet interface, a Universal Serial Bus (USB) interface, an IEEE 1394 (Firewire) interface, an external Serial Advanced Technology Attachment (eSATA) interface, or any other physical connection interface suitable for communication with the user computing device. Alternatively, interface 115 may be a wireless interface, such as a wireless local area network (WLAN) interface or a near-field communication (NFC) interface. In operation, as detailed below, interface 115 may be used to send and receive data, such as face profile data and shared content data, to and from a corresponding interface of a cloud server.

Capture device 118 may include one or more image sensors for capturing images that are stored on the computing device 100. For example, capture device 118 may be an embedded camera device, a web camera, an Internet protocol (IP) camera, an overhead camera, or any other camera device suitable for capturing images.

Machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. As described in detail below, machine-readable storage medium 120 may be encoded with executable instructions for detecting a receiving user for ad-hoc, face-recognition-driven content sharing.

Video stream processing instructions 122 may process a video stream obtained by capture device 118. Specifically, video stream processing instructions 122 may detect faces of potential receiving users in the video stream and then extract face images from the video stream to send to a cloud service for processing. In some cases, video stream processing instructions 122 may be configured to detect motion in the video stream in order to determine when the video stream should be processed for face detection. The detected face images may be provided to the cloud service in a request for face recognition processing, where the results of the face recognition processing are received by temporary token receiving instructions 124 as discussed below.

Temporary token receiving instructions 124 may receive a temporary token from the cloud service in response to the face images provided by video stream processing instructions 122. The temporary token may be associated with a face profile of a potential receiving user that has previously registered with the cloud service. In this case, a temporary token is provided by the cloud service to maintain the privacy of the receiving user (i.e., a randomly generated identifier is provided in lieu of personal information for identifying the receiving user). The cloud service may also provide an arbitrary alias that is associated with the receiving user. The arbitrary alias may have been designated by the receiving user when his face profile was generated by the cloud service.

A face profile may include facial characteristics (e.g., relative position, size, and shape of facial features such as the eyes, nose, cheekbones, and chin) of a receiving user as determined based on facial recognition training performed by the cloud service. For example, eigenfaces or fisherfaces based algorithms may be used by the cloud service to generate the facial profiles. In order for a receiving user to participate in sharing, facial recognition training should initially be performed based on training face images received from a training device (e.g., smartphone, desktop computer, laptop computer) of the receiving user. In some cases, the training device may be the same as a receiving device of the receiving user, where the receiving device is a potential target for shared content from computing device 100. In this case, the receiving user need only register once with the cloud service and then may be authenticated by a sharing device as discussed below.

Shared content transmitting instructions 126 may send a context identifier and return the temporary token to the cloud service so that the context identifier can be shared with the receiving user associated with the temporary token. The context identifier and temporary token may be sent in response to the receiving user verifying the arbitrary handle. For example, the user of computing device 100 may request that the receiving user verify that the arbitrary handle matches the handle the receiving user preconfigured in his face profile. If the receiving user verifies the arbitrary handle, the user of the computing device 100 may initiate the shared content transmitting instructions 126 so that the context identifier can be sent to the cloud service for sharing with the receiving device of the receiving user.

FIG. 2 is a block diagram of an example cloud server 200 for providing ad-hoc, face-recognition-driven content sharing. Cloud server 200 may be a modular server such as a rack server or a blade server or some other computing device dedicated to providing one or more services (e.g., face recognition services, cloud sharing services, etc.) as described below. In the embodiment of FIG. 2, cloud server 200 includes processor 210, interface 215, and machine-readable storage medium 220.

As with processor 110 of FIG. 1, processor 210 may be one or more CPUs, microprocessors, and/or other hardware devices suitable for retrieval and execution of instructions. Processor 210 may fetch, decode, and execute instructions 222, 224, 226, 228 to implement ad-hoc, face-recognition-driven content sharing. Processor 210 may also or instead include electronic circuitry for performing the functionality of one or more instructions 222, 224, 226, 228. As with interface 115 of FIG. 1, interface 215 may include electronic components for wired or wireless communication with server computing device. As described above, interface 215 may be in communication with a corresponding interface of a computing device to send or receive face profile data or shared content data. As with storage medium 120 of FIG. 1, machine-readable storage medium 220 may be any physical storage device that stores executable instructions.

Face profile generating instructions 222 may generate a face profile using a training face images received from a training device during a registration process for the receiving user. The training device may be controlled by the receiving user to obtain the training face images. In some cases, the training device may be the same as a receiving device of the receiving user. Cloud server 200 may analyze the training face images to determine facial characteristics (e.g., relative position, size, and shape of facial features such as the eyes, nose, cheekbones, and chin) of the receiving user's face. Cloud server 200 may determine facial characteristics from each of the training face images to refine the facial profile (e.g., verify and/or determine characteristics, determine average positions and distances across multiple images, etc.). Once, the facial profile is generated, cloud server 200 may store the face profile and associate it with the receiving user. Further, the cloud server 200 may also request that the receiving user specify an arbitrary alias to include in the facial profile. The arbitrary alias is arbitrary in that it does not necessarily include any personal information of the receiving user, Face profile generating instructions 222 may generate face profiles to register a number of receiving users with the cloud server 200. Once the receiving user is registered with the cloud server 200, cloud sharing sessions may be initiated with the receiving device without receiving any further face images from the receiving device.

Face images receiving instructions 223 may receive face images from a sharing device. The sharing device may be initiating a sharing session with potential receiving users in the face images and requesting cloud recognition processing from cloud server 200. Face images receiving instructions 223 may perform face recognition on the face images to identify a matching face profile of a registered receiving user.

Temporary token generating instructions 224 may generate a temporary token in response to identifying a receiving user in a face image from the sharing device. For example, the temporary token may be a randomly generated globally unique identifier (GUID) that is associated with the face profile for a cloud sharing session. The temporary token may be associated with the face profile of the receiving user so that the cloud server 200 may use the temporary token in future requests to identify the receiving user. Because the temporary token expires after a predetermined duration, cloud server 200 may verify that the face has been detected recently as opposed to a sharing device holding on to an arbitrary handle and resending or spamming content at a later time. After a temporary token is generated, temporary token sending instructions 226 may send the temporary token and the arbitrary alias of the associated face profile to the sharing device that provided the video stream. The temporary token and arbitrary handle may then be used by the sharing device to verify the receiving user before content is shared with the receiving device.

Shared content providing instructions 228 may share content from the sharing device to the receiving device associated with the temporary token. A context identifier may be transmitted to cloud server 200 by the sharing device after the arbitrary handle is verified by the receiving user. In this case, the temporary token is used to identify the face profile of the receiving user, where the face profile is also associated with the receiving device. Once the receiving device is determined, the context identifier may be provided by cloud server 200 to the receiving device.

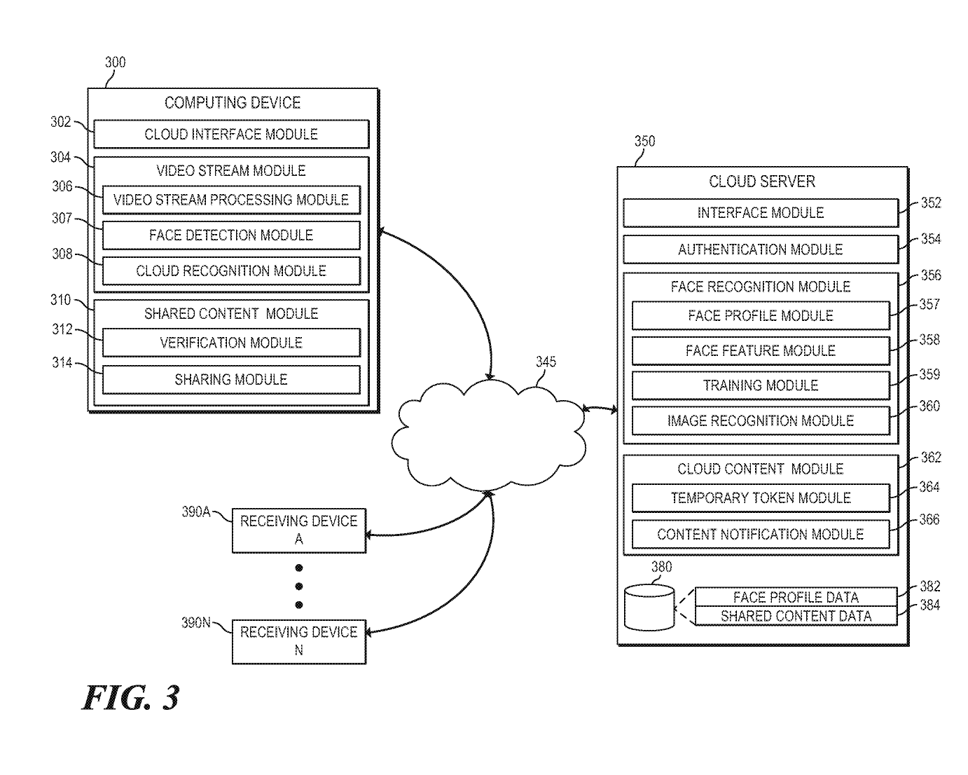

FIG. 3 is a block diagram of an example cloud server 350 in communication via a network 345 with a computing device 300. As illustrated in FIG. 3 and described below, cloud server 350 may communicate with computing device 300 to provide ad-hoc, face-recognition-driven content sharing to receiving devices (e.g., receiving device A 390A, receiving device N 390N).

As illustrated, computing device 300 may include a number of modules 302-314, while cloud server 350 may include a number of modules 352-366. Each of the modules may include a series of instructions encoded on a machine-readable storage medium and executable by a processor of the respective device 300, 350. In addition or as an alternative, each module may include one or more hardware devices including electronic circuitry for implementing the functionality described below.

As with computing device 100 of FIG. 1, computing device 300 may be a smartphone, notebook, desktop, tablet, workstation, mobile device, or any other device suitable for executing the functionality described below. As detailed below, computing device 300 may include a series of modules 302-314 for enabling detecting a receiving user for ad-hoc, face-recognition-driven content sharing.

Cloud interface module 302 may manage communications with the cloud server 350. Specifically, the cloud interface module 302 may initiate connections with the cloud server 350 and then send or receive face profile data 382 and shared content data 384 to/from the cloud server 350.

Video stream module 304 may process a video stream of a capture device (not shown) of computing device 300. Although the components of video stream module 304 are described in detail below, additional details regarding an example implementation of video stream module 304 are provided above in connection with instructions 122-124 of FIG. 1.

Video stream processing module 306 may monitor the video stream to detect faces for submitting to cloud server 350 for face recognition analysis. For example, face images may be extracted from the video stream and then provided to cloud server 350 whenever a face is detected. Face detection module 307 may analyze the video stream to detect the faces of potential receiving users for video stream processing module 306. For example, an object-class detection algorithm specifically configured to detect facial features may be used to detect faces in the video stream.

In this example, cloud recognition module 308 may then send the face images that are extracted from the video stream to cloud server 350 for the face recognition analysis and then forward the results (e.g., temporary token and arbitrary handle) of the face recognition analysis to shared content module 310.

Shared content module 310 may manage content for sharing with a receiving device (e.g., receiving device A 390A, receiving device N 390N). Although the components of shared content module 310 are described in detail below, additional details regarding an example implementation of shared content module 310 are provided above in connection with instructions 126 of FIG. 1.

Verification module 312 may provide a user interface to a sharing user for verifying an arbitrary handle of a potential receiving user. For example, the user interface may present the arbitrary handle under an image of the user and request that the sharing user confirm that the arbitrary handle is associated with the potential receiving user. The user interface may be presented in a web browser. Alternatively, the user interface may be presented in a stand-alone application. In this example, the sharing user may manually request that the potential receiving user verify that the arbitrary handle is associated with the receiving user and then confirm or deny the arbitrary handle in the user interface based on the potential receiving user's response. The in-person, manual verification helps prevent the sharing of content with unauthorized users.

Sharing module 314 may provide content and return the temporary token to cloud server 350 so that the content can be shared with receiving devices (e.g., receiving device A 390A, receiving device N 390N). Specifically, in response to the arbitrary handle being manually verified by the receiving user, the sharing user may confirm that the content should be shared, and the sharing module 314 may send a content identifier or a context identifier to the cloud server 350 for sharing with the receiving device (e.g., receiving device A 390A, receiving device N 390N). The cloud server 350 may use the temporary token to identify the receiving device (e.g., receiving device A 390A, receiving device N 390N) of the receiving user.

A context identifier may be associated with a shared context of the computing device 300 that may include shared content. In this example, the shared context may correspond to the physical location where the computing device 300 is located, where the computing device 300 shares content with receiving users at the physical location. A receiving device (e.g., receiving device A 390A, receiving device N 390N) that is granted access to the shared context may use the shared content to access streams of content provided by the computing device 300 as the streams become available. For example, the computing device 300 may share a presentation and supporting documents in the shared context. A content identifier may be associated with a particular stream of content provided by the computing device 300. In this case, the receiving device (e.g., receiving device A 390A, receiving device N 390N) may only access the particular stream of content provided by the computing device 300.

As generally described herein, content may be enhanced with the users' context, such as, for example, the users' location, organization, project, workgroup, virtual team, workshop, event, etc. Users' annotations and meta information such as related links, notes and instant messaging chats may all be tied to the part of the content the users are referring to at any given time in a shared context.

As with cloud server 200 of FIG. 2, cloud server 350 may be any server accessible to computing device 300 over a network 345 that is suitable for executing the functionality described below. As detailed below, cloud server 350 may include a series of modules 352-366 for providing ad-hoc, face-recognition-driven content sharing.

Interface module 352 may manage communications with the computing device 300. Specifically, the interface module 352 may initiate connections with the computing device 300 and then send or receive face profile data 382 and shared content data 384 to/from the computing device 300. Interface module 352 may also process login credentials of a sharing user to authorize access by the computing device 300 to the cloud server 350. Specifically, the interface may first request login information from the sharing user and, upon receipt of the login information, request that authentication module 354 determine whether the sharing user is properly authenticated. If the sharing user is properly authenticated, interface module 352 may then present an additional interface that allows the sharing user to access cloud sharing services provided by the cloud server 350.

Face recognition module 356 may manage face recognition analysis for identifying receiving users. Although the components of face recognition module 356 are described in detail below, additional details regarding an example implementation of face recognition module 356 are provided above in connection with instructions 222-224 of FIG. 2.

Face profile module 357 may generate face profiles based on training face images extracted from training video streams that are captured by a training device of a receiving user. In some cases, the training device the receiving user may be the same as the receiving device (e.g., receiving device A 390A, receiving device N 390N). The training face images may be used to identify the facial characteristics of a receiving user, which are then used to generate a corresponding face profile. The face profile may also include (1) an arbitrary alias as designated by the receiving user and (2) data identifying the receiving device (e.g., receiving device A 390A, receiving device N 390N) of the receiving user. The facial profiles may be stored as facial profile data 382 in storage device 380.

Face feature module 358 may be used by face profile module 357 to generate facial features for the face profile. For example, eigenfaces or fisherfaces based algorithms may be used by the face feature module 358 to extract arbitrary features from variation-based representations of the training face images.

Training module 359 may use the face feature module 358 to train the facial features in the face profile. For example, training module 359 may process further training face images of receiving user to refine the facial features in the face profile.

Image recognition module 360 may identify receiving users in face images extracted from the video streams that are captured by computing device 300. Specifically, image recognition module 360 may attempt to match face images to face profiles stored in face profile data 382 of storage device 380. If a face is matched to a face profile, the matching face profile may be provided to cloud content module 362 for further processing.

Cloud content module 362 may manage cloud content sharing for receiving users. Although the components of cloud content module 362 are described in detail below, additional details regarding an example implementation of cloud content module 362 are provided above in connection with instructions 224-228 of FIG. 2.

Temporary token module 364 may initiate cloud sharing with a receiving device (e.g., receiving device A 390A, receiving device N 390N) by providing temporary tokens. In response to a face image of a receiving user being matched to a face profile by image recognition module 360, temporary token module 364 may randomly generate a temporary token that is associated with the face profile of the identified receiving user. Temporary token module 364 may then send the temporary token and an associated arbitrary handle to computing device 300 via interface module 352 for verification as discussed above. If the temporary token is verified, the temporary token may then be provided with content from computing device 300 for sharing. In some cases, the temporary token is configured to expire after a predetermined amount of time. The expiration of the temporary token ensures that it may not be used in perpetuity to share content with an associated receiving device (e.g., receiving device A 390A, receiving device N 390N).

Content notification module 368 may notify receiving devices (e.g., receiving device A 390A, receiving device N 390N) of shared content on computing device 300. When a verified temporary token is received by cloud context module 366, a content identifier or context identifier for shared content on computing device 300 may be shared with a receiving device (e.g., receiving device A 390A, receiving device N 390N) that is associated with the temporary token. The receiving device may be identified using the face profile that was associated with the temporary token when it was generated by temporary token module 364. The content to be shared may be accessed directly from the computing device 300 by the receiving device (e.g., receiving device A 390A, receiving device N 390N). Content and context identifiers may be stored as shared content data 384 in storage device 380.

Storage device 380 may be any hardware storage device for maintaining data accessible to cloud server 350. For example, storage device 380 may include one or more hard disk drives, solid state drives, tape drives, and/or any other storage devices. The storage devices may be located in cloud server 350 and/or in another device in communication with cloud server 350. As detailed above, storage device 380 may maintain face profile data 382 and shared content data 384.

Receiving devices (e.g., receiving device A 390A, receiving device N 390N) may be mobile devices such as tablets, laptop computers, smartphones, etc. with access to the network 345. Once a receiving user of a receiving device (e.g., receiving device A 390A, receiving device N 390N) is verified, the receiving device may access shared content from cloud server 350 via a web browser or stand-alone application. For example, the receiving device (e.g., receiving device A 390A, receiving device N 390N) may be able to access a presentation being shared by computing device 300 through cloud server 350.

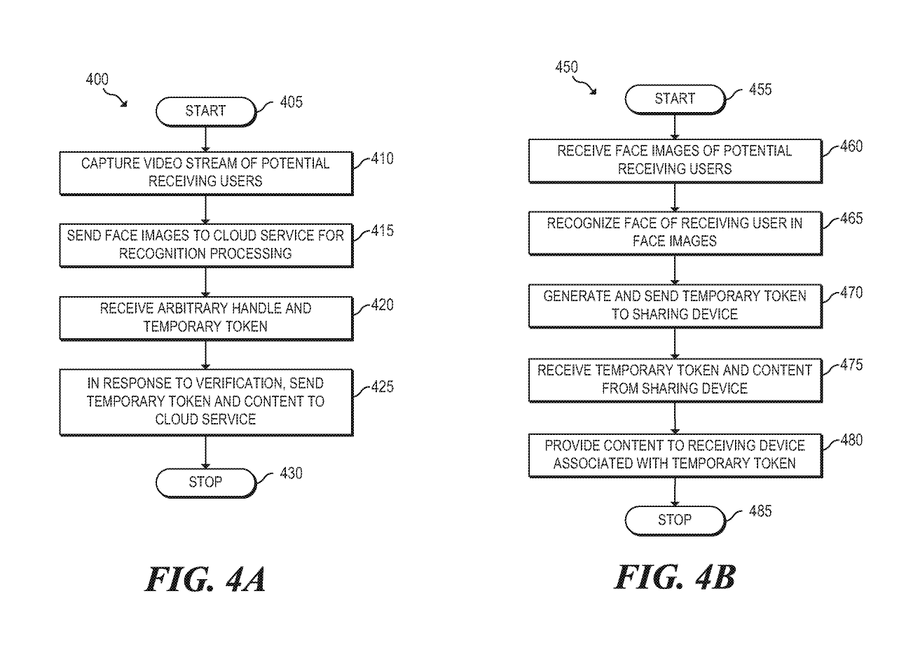

FIG. 4A is a flowchart of an example method 400 for execution by a computing device 100 for detecting a receiving user for ad-hoc, face-recognition-driven content sharing. Although execution of method 400 is described below with reference to computing device 100 of FIG. 1, other suitable devices for execution of method 400 may be used, such as computing device 300 of FIG. 3. Method 400 may be implemented in the form of executable instructions stored on a machine-readable storage medium, such as storage medium 120, and/or in the form of electronic circuitry.

Method 400 may start in block 405 and continue to block 410, where computing device 100 may capture a video stream of potential receiving users. For example, computing device 100 may be operatively connected to a camera in a conference room that is capturing a video stream of the participants. If multiple potential receiving users are included in the video stream, the receiving users may be processed sequentially as discussed below. At this stage, computing device 100 may send face images from the video stream to a cloud service for processing in block 415. For example, computing device 100 may be configured to detect faces in the video stream and then extract face images from the video stream for sending to the cloud service for face recognition analysis. The submitted face images include the face of a potential receiving user, who is identified by the face recognition analysis of the cloud service.

In block 420, computing device 100 may receive an arbitrary handle and temporary token resulting from the face recognition analysis performed by the cloud service. The temporary token may be associated with a face profile of the potential receiving user, and the arbitrary handle may be associated with the potential receiving user. Once the arbitrary handle is received, the sharing user of computing device 100 may request that the potential receiving user verify the arbitrary handle. If the arbitrary handle is verified, computing device 100 may send the temporary token and content to be shared with the receiving user to the cloud service. In some cases, the content may be a context identifier or a content identifier for a cloud context or shared content that is already stored by the cloud service. Method 400 may subsequently proceed to block 430, where method 400 may stop.

FIG. 4B is a flowchart of an example method 450 for execution by a cloud server 200 for providing ad-hoc, face-recognition-driven content sharing. Although execution of method 450 is described below with reference to cloud server 200 of FIG. 2, other suitable devices for execution of method 450 may be used, such as cloud server 350 of FIG. 3. Method 450 may be implemented in the form of executable instructions stored on a machine-readable storage medium, such as storage medium 220, and/or in the form of electronic circuitry.

Method 450 may start in block 455 and proceed to block 460, where cloud server 200 may receive face images of potential receiving users. Cloud server 200 may process the face images to recognize the face of a potential receiving user in block 465. The face of the potential receiving user may be recognized by matching the face in the face image to a face profile in the pre-registered database of users on cloud server 200.

In block 470, if a matching face profile is found, cloud server 200 may generate a temporary token that is associated with the matching face profile and send the temporary token to the sharing device. Cloud server 200 may also send an arbitrary handle of the potential receiving user to the sharing device for verification. If the arbitrary handle is verified, the temporary token and a context identifier may be received by cloud server 200 from the sharing device in block 475. Receipt of the temporary token and the context identifier may be considered notification that the potential receiving user has been verified.

Next, in block 480, cloud server 200 may provide the context identifier to a receiving device based on the temporary token. Specifically, information for connecting to the receiving device (e.g., media access control (MAC) address, etc.) may be retrieved from the face profile that is associated with the temporary token. The receiving device may then be provided with the context identifier so that it can access the content from the sharing device. In this example, the context identifier may be transmitted to the receiving device over a bi-directional socket, which may also be used by the receiving device to send messages to the sharing device. Method 450 may subsequently proceed to block 485, where method 450 may stop.

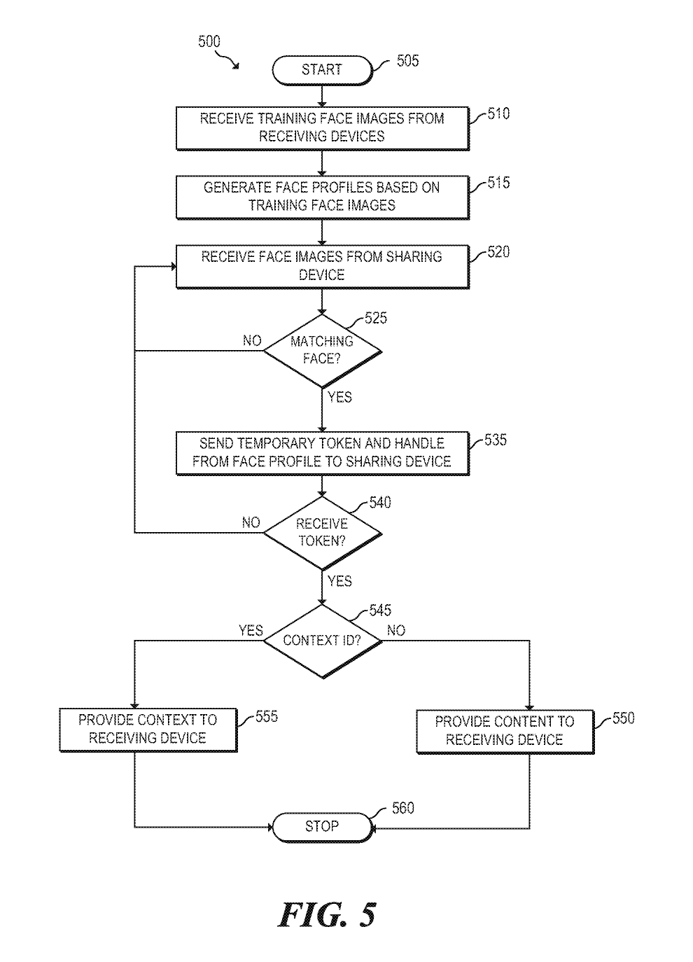

FIG. 5A is a flowchart of an example method 500 for execution by a cloud server 350 for providing ad-hoc, face-recognition-driven content sharing for a computing device 300. Although execution of method 500 is described below with reference to cloud server 350 of FIG. 3, other suitable devices for execution of method 500 may be used. Method 500 may be implemented in the form of executable instructions stored on a machine-readable storage medium and/or in the form of electronic circuitry.

Method 500 may start in block 505 and proceed to block 510, where cloud server 350 may receive training face images from receiving devices. The training face images are used to register receiving users of the receiving devices with the cloud server 350. A training face image includes a face of a receiving user requesting registration. In this case, cloud server 350 generates a face profile for the receiving user based on the face as shown in the training face image in block 515. Cloud server 350 may separately register each of the receiving users based on their respective training face image(s).

In block 520, a content face image is received from a sharing device (i.e., computing device 300). For example, the content face image may be extracted from a video stream of a conference room in which the sharing device is displaying a presentation. The content face image may include multiple potential receiving users for sharing content. Next, in block 525, cloud server 350 may determine if any faces in the content video stream match a face profile. If there are no matching face profiles, method 500 returns to block 520 to process additional images from the content video stream.

If a matching face profile is detected, cloud server 350 may generate and send a temporary token for the matching face profile to sharing device in block 535. For example, the temporary token may be a randomly generated GAD that is associated with the matching face profile. At this stage in block 540, cloud server 350 determines if the temporary token is returned from the sharing device. If the temporary token is returned, cloud server 350 determines that the potential receiving user is not verified, and method 500 returns to block 520 to process additional face images from the content video stream.

If the temporary token is from the sharing device, cloud server 350 determines that the potential receiving user is verified and initiates content sharing by determining if a context exists in block 545. Specifically, cloud server 350 determines whether the sharing device provided a context identifier or a content identifier. If a context identifier is provided, cloud server 350 may provide the context identifier to the receiving device that is associated with the temporary token in block 555. In this example, the context identifier may correspond to the physical location (e.g., conference room) of the sharing device and may be used by the receiving device to access content shared by the sharing device at the physical location. In this example, the context identifier may be transmitted to the receiving device over a bi-directional socket, which may also be used by the receiving device to send messages to the sharing device.

If a content identifier is provided, cloud server 350 may provide the content identifier to the receiving device associated with the temporary token in block 550. The receiving device may then use the content identifier to access shared content from the sharing device. The steps in blocks 510-555 may be repeated for a number of receiving users as each enters the field of view of a camera connected to the sharing device. Method 500 may then proceed to block 560, where method 500 may stop.

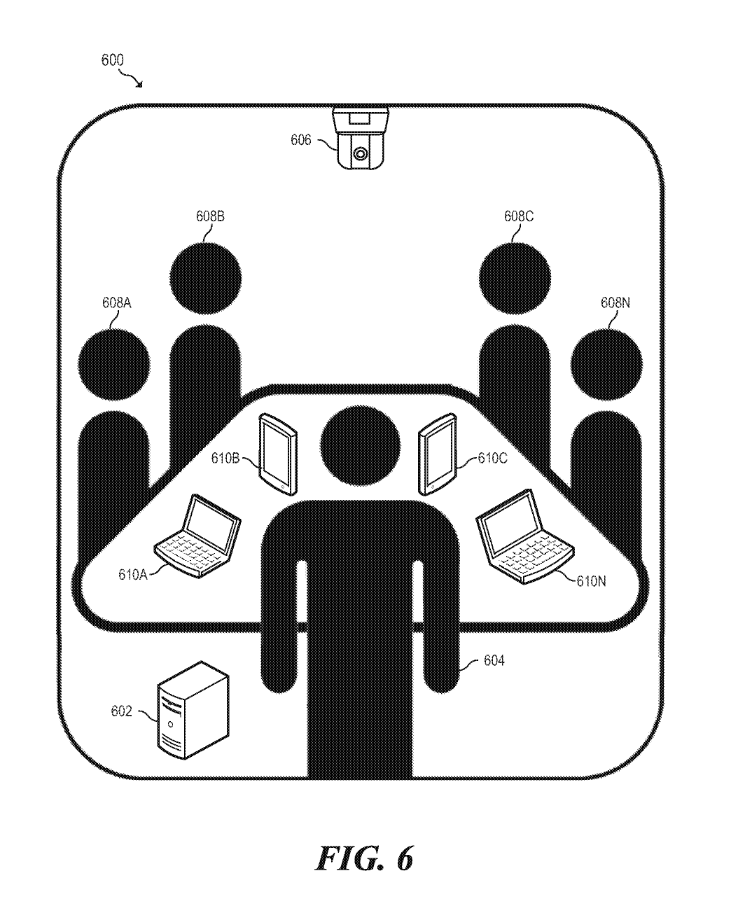

FIG. 6 is a diagram of an example context 600 in which content is shared by ad-hoc, face-recognition-driven authentication. As depicted, the example context 600 is a conference room including a sharing user 604 and receiving users 608A, 608B, 608C, 608N. The sharing user 604 is operating a sharing device 602 that is connected to an overhead camera 606. Each of the receiving users 608A, 608B, 608C, 608N is operating a receiving device 610A, 610B, 610C, 610N. The overhead camera 606 is capturing a video stream that includes the face of each of the receiving users 608A, 608B, 608C, 608N. Sharing device 602 may extract images from the video stream and send the images to a cloud service for face recognition analysis.

After the face recognition analysis is performed, sharing device 602 may receive a temporary token and corresponding arbitrary handle for each of the receiving users 608A, 608B, 608C, 608N. At this stage, sharing user 604 may verify the corresponding arbitrary handle with each of the receiving users 608A, 608B, 608C, 608N. As the arbitrary handles are verified, sharing device 602 sends the temporary tokens to the cloud service along with content for sharing with the receiving devices 610A, 610B, 610C, 610N. The cloud service may then identify the receiving devices 610A, 610B, 610C, 610N using the temporary tokens and provide the content for the receiving users 608A, 608B, 608C, 608N. In this manner, content may be shared with receiving users as they enter the field of view of overhead camera 606 without using typical login credentials.

The foregoing disclosure describes a number of example embodiments for providing ad-hoc, face-recognition-driven authentication by a cloud server. In this manner, the embodiments disclosed herein enable ad-hoc sharing of content by using a camera device to perform face recognition and verification of receiving users.

We claim:

1. A system for providing ad-hoc, face-recognition-driven content sharing, the system comprising:
a processor to:
match a face in a face image from a sharing device to a face profile of a receiving user, wherein the face profile of the receiving user is generated based on a training face image that is extracted from a training video stream of a training device of the receiving user;
send, in response to generating a temporary token that is associated with the face profile, the temporary token and an arbitrary handle from the face profile to the sharing device;
receive a context identifier from the sharing device; and
use the temporary token to provide the context identifier to a receiving device of the receiving user, wherein the receiving device uses the context identifier to access shared content from the sharing device.

2. The system of claim 1, wherein the context identifier is transmitted to the receiving device over a bi-directional socket that is also used by the receiving device to communicate with the sharing device.

3. The system of claim 1, wherein the processor is further to:
use the temporary token to identify the face profile associated with the receiving device.

4. The system of claim 1, wherein the processor is further to:
receive the training face image from the receiving device, wherein the face profile comprises arbitrary features that are extracted from a variation-based representation of the training face image.

5. The system of claim 1, wherein the temporary token is a randomly generated globally unique identifier.

6. The system of claim 1, wherein the sharing device and the receiving device are at a common physical location, and wherein the receiving user manually verifies the arbitrary handle with a sharing user of the sharing device.

7. A method for providing ad-hoc, face-recognition-driven content sharing, the method comprising:
matching a face in a face image from a sharing device to a face profile of a receiving user, wherein the face profile of the receiving user is generated based on training face image that is extracted from a training video stream of a training device of the receiving user;
in response to generating a temporary token that is associated with the face profile, sending the temporary token and an arbitrary handle from the face profile to the sharing device;
receiving the temporary token and shared content from the sharing device; and
using the temporary token to provide the shared content to a receiving device of the receiving user, wherein the temporary token is used to identify the face profile associated with the receiving device.

8. The method of claim 7, wherein the context identifier is transmitted to the receiving device over a bi-directional socket that is used by the receiving device to access the cloud context.

9. The method of claim 7, further comprising:
receiving the training video stream from the receiving device, wherein the face profile comprises arbitrary features that are extracted from a variation-based representation of the training face image.

10. The method of claim 7, wherein the temporary token is a randomly generated globally unique identifier.

11. The method of claim 7, wherein the sharing device and the receiving device are at a common physical location, and wherein the receiving user manually verifies the arbitrary handle with a sharing user of the sharing device.

12. A non-transitory machine-readable storage medium encoded with instructions executable by a processor, the machine-readable storage medium comprising instructions to:
send a face image extracted from a video stream to a cloud service, wherein the cloud service recognizes a face of a receiving user in the face image;
receive, from the cloud service, an arbitrary handle that is associated with the receiving user and a temporary token that is associated with a face profile of the receiving user, wherein the face profile of the receiving user is generated based on a training face image extracted from a training video stream of a training device of the receiving user; and
transmit, in response to the receiving user verifying the arbitrary handle, a context identifier to the cloud service, wherein the cloud service uses the temporary token to provide the context identifier to a receiving device of the receiving user.

13. The machine-readable storage medium of claim 12, wherein the receiving devices uses the context identifier to access shared content from a sharing device.

14. The machine-readable storage medium of claim 12, wherein the temporary token is matched to the face profile by the cloud service to authorize access to the shared content for the receiving device.

15. The machine-readable storage medium of claim 12, wherein the receiving device a sharing device that comprises the machine-readable storage medium are at a common physical location, and wherein the receiving user manually verifies the arbitrary handle with a sharing user of the sharing device.
